(19) United States
(12) Patent Application Publication
(10) Pub. No.: US 2013/0036008 A1
(43) Pub. Date: Feb. 7, 2013

(54) METHOD AND ARRANGEMENT FOR SUPPORTING ADVERTISING

(71) Applicants: Johan Englund, Stockholm (SE); Niklas Björkén, Bandhagen (SE)

(72) Inventors: Johan Englund, Stockholm (SE); Niklas Björkén, Bandhagen (SE)

(73) Assignee: Telefonaktiebolaget L M Ericsson (publ), Stockholm (SE)

(21) Appl. No.: 13/575,235

(22) PCT Filed: Feb. 11, 2010
(86) PCT No.: PCT/SE10/50159

§ 371 Date: Oct. 9, 2012

(51) Int. Cl. G06Q 30/02

(52) U.S. Cl. 705/14.53

(57) ABSTRACT

A method and arrangement for supporting advertising activities directed to one or more inhabitants of a residence. An RFID tag or bar code is attached to consumer products that can be detected and read by an electronic identity reader when each consumer product is brought into the residence. The RFID tag or bar code contains information relating to, e.g., the type or characteristics of the detected consumer product. The product information is then sent to a profile server, which creates a consumer profile for the residence inhabitant(s) based on the received information. Thereby, advertisements can be delivered which are adapted to the needs and preferences of one or more inhabitants of a residence based on their presumed purchase and usage of consumer products or appliances which have entered the residence.

### TECHNICAL FIELD

The invention relates generally to a method and arrangement for providing a basis for relevant or personalised advertising.

### BACKGROUND

Today, much development has been directed to solutions for providing advertisements and offerings to potential customers which are adapted to the needs and preferences of the receiving customers, sometimes referred to as “targeted advertising”. Naturally, it is of interest for product and service providers to advertise or offer particularly relevant products and services to customers that are interested and thus more likely to make a purchase. In addition to conventional advertising in paper form sent to consumers in their homes, the medium of IPTV is particularly interesting and useful as a means for delivering targeted advertising to individual residences and households.

So-called recommendation systems have further been devised for sellers and advertisers, which are based on previous purchases of the customers and/or previous purchases of other customers having purchased the same or similar products, commonly referred to as “collaborative filtering”. For example, if one customer is browsing an Internet site in search for a particular product, the site may automatically suggest other products, saying: “Customers that have bought this product have also bought the following products: . . . ” Other systems may rely on previous purchases made by the customer as registered by the selling party.

However, the above solutions are somewhat limited with respect to the information on customers available to a particular seller, advertiser or the like, on which the advertisements are typically based. Typically, such information is only available for products or services that have been offered and delivered by that selling party, unless an agreement is established between multiple sellers or advertisers to share information on registered customer activities. This would of course require that the purchases or browsing activities of customers are registered and stored in a preferably standardised manner, as well as requiring a process for exchanging this kind of information between the selling parties. Nevertheless, such information still provides a rather narrow view of the customer's consuming habits by referring to a limited selection of consumed products or services.

Another problem today is the huge amount of more or less irrelevant advertisements being constantly hurled at potential consumers, in paper form, e-mails, TV commercials, and so forth. As a result, many people become indifferent or even irritated and make considerable efforts to avoid this stream of advertisements by means of various blocking measures. It is therefore difficult for sellers of potentially interesting products and services to actually reach consumers that would be genuinely interested in buying the offered product or service.

### SUMMARY

It is an object of the invention to address at least some of the problems outlined above. It is also an object to provide more relevant advertisements to consumers living in individual residences and households. It is possible to achieve these objects and others by using a method and an arrangement as defined in the attached independent claims.

According to one aspect, a method is provided for supporting advertising activities directed to one or more inhabitants of a residence. In this method, information is received regarding consumer products or appliances that have entered the residence as detected by an electronic identity reader installed at the residence. A consumer profile is also created for the residence inhabitant(s) based on the received product information, where the consumer profile relates to a purchasing behaviour and/or consuming behaviour. The consumer profile is then provided to an advertising function to enable creation of a consumer adapted advertisement and/or offering that is adapted to the residence inhabitant(s).

Thereby, more relevant advertisements can be delivered to the consumers by taking their presumed purchase and usage of any products into account when creating the consumer profile, without limitation to any particular products as long as they have readable product information.

According to another aspect, an arrangement in a profile server is provided that is configured to support advertising activities directed to one or more inhabitants of a residence. According to this arrangement, the profile server comprises a receiving module adapted to receive information regarding consumer products or appliances that have entered the residence as detected by an electronic identity reader installed at the residence. The profile server also comprises a logic module adapted to create a consumer profile for the residence inhabitant(s) based on the received product information, the consumer profile relating to a purchasing behaviour and/or consuming behaviour, and a providing module adapted to provide the consumer profile to an advertising function to enable creation of a consumer adapted advertisement and/or offering that is adapted to the residence inhabitant(s).

The above method and arrangement may be configured and implemented according to different embodiments. In one embodiment, the electronic identity reader is an RFID (Radio Frequency Identification) reader or a bar code reader which detects at least an identity from an RFID tag or bar code attached to a consumer product or appliance entering the residence. Further, the profile server may receive the product information from a communication equipment to which the electronic identity reader is connected, where the communication equipment may include a gateway serving a local network in the residence, or a sending unit integrated with the electronic identity reader.

According to further possible embodiments, the consumer products or appliances that can be detected by the electronic identity reader belong to any of: consumer electronic devices, home appliances, books, music, films, clothes, food, furniture and tools. The advertising function is able to deliver the consumer adapted advertisement and/or offering to the residence, e.g. using any of: an IPTV channel, a telephone message, a paper and an e-mail.

In other possible embodiments, the received product information relates to any of: type of detected consumer product and characteristics of detected consumer product. Creating the consumer profile may further include determining expected preferences or needs of the residence inhabitant(s) based on assumed usage of the detected consumer products.

Further possible features and benefits of this solution will become apparent from the detailed description below.

### BRIEF DESCRIPTION OF DRAWINGS

The invention will now be described in more detail by means of some exemplary embodiments and with reference to the accompanying drawings, in which:

FIG. 1 is a schematic block diagram illustrating a communication scenario according to one possible embodiment.

FIG. 2 is a schematic block diagram illustrating an alternative communication scenario, according to another possible embodiment.

FIG. 3 is a flow chart with steps performed by an advertising support arrangement in a server or the like, according to further exemplary embodiments.

FIG. 4 is a block diagram illustrating in more detail an advertising support arrangement, according to further exemplary embodiments.

### DETAILED DESCRIPTION

In the following, the term “advertisement” is used to represent any form of communication to a potential customer that offers a product or service to the customer, e.g. using an IPTV channel, a telephone message, a paper or an e-mail as a medium for communication. The invention is not limited to any particular way of presenting an advertisement. Further, the term “consumer product” represents virtually any product that a consumer can acquire and bring into a residence for use or “consummation”, of which some non-limiting examples are: electronic devices, home appliances, books, music, films, clothes, food, furniture and tools. A “residence” should further be understood as any house, building, apartment or flat where one or more potential consumers are basically living as “inhabitants” of a household.

Briefly described, a solution is provided to enable an advertising function to deliver advertisements to specific residences which are adapted to the needs and preferences of one or more inhabitants of a residence based on their presumed purchase and usage of consumer products or appliances which have entered the residence. In this solution, an RFID tag or bar code attached to the consumer product can be detected and read by an electronic identity reader when the consumer product is brought into the residence. The RFID tag or bar code contains information on the consumer product, and may relate to the type of detected consumer product or characteristics of the product.

Each time product information is read by the electronic identity reader as a product enters the residence having the above-described RFID tag or bar code, the product information is sent to a profile server which stores the received information for that residence. After having received such information on a plurality of consumer products or appliances that have entered the residence, the profile server is able to create a consumer profile for the residence inhabitant(s) based on the received product information. However, a consumer profile can basically be created based on any number of registered products having entered the residence and the invention is not limited in this respect.

In more detail, a logic function in the profile server is configured to derive preferences or needs of the residence inhabitant(s) based on assumed purchase and usage of the detected consumer products as they have been brought to the residence, and to create the consumer profile reflecting these preferences or needs. The profile server then sends the created consumer profile to an advertising function for creation of an adapted advertisement based on the consumer profile. Thereby, it is possible to adapt the advertisement according to the preferences and needs of the one or more residence inhabitants by taking the consumer profile into account.

For example, if a particular electronic game station has entered the residence known to have capabilities to operate a certain type of electronic games, the profile server may indicate a preference for such electronic games in the consumer profile, and an advertisement that offers such games will probably be of interest to at least one inhabitant of the residence. In another example, it has been detected that a large flat screen TV of high definition has entered the residence, and the resulting consumer profile may then indicate an interest for disc players of high quality and/or movies in a high definition format.

FIG. 1 illustrates a communication scenario where this solution is used, according to a first example. In the figure, a residence 100 is schematically shown, in this case a house although the residence could also be an apartment, flat or room in a larger building with plural other households. One or more inhabitants live in the residence 100, which are potential consumers of products or services that can be advertised as described herein. The residence 100 may even be a hotel room or the like with temporary inhabitants.

An electronic identity reader 102 is installed at the residence 100, which is configured to register a consumer product 104 whenever entering the residence 100, by detecting and reading an RFID tag or bar code attached to the product 104. The RFID tag or bar code contains information on the consumer product relating to the type of detected consumer product or characteristics of the product, which is thus read by the electronic identity reader 102.

In this figure, a laptop computer is illustrated as an exemplary consumer product 104, although any type of consumer product having an RFID tag or bar code with such information may be registered in this way, as explained above. The electronic identity reader 102 may be installed basically anywhere at the residence 100, but it may be practical to position it at the main entrance door. Otherwise, the reader 102 may be integrated in a so-called Set Top Box (STP) at a TV set. Even though it may be most practical to use RFID tags not requiring “line-of-sight” to be read, the invention does not exclude the use of bar codes or similar.

When the entered consumer product 104 has been registered, the electronic identity reader 102 outputs the read product information. In this example, the electronic identity reader 102 is connected to a home gateway 106 that serves a local network 108 in the residence. The reader 102 sends the read product information over network 108 to gateway 106 for further communication to a profile server 110, which is configured to receive and store such information on consumer products whenever read by the electronic identity reader 102.

In this way, the profile server 110 may thus receive information regarding any number of registered consumer products having entered the residence 100, on a continuous basis. At some point, a logic function 110a in the profile server 110 creates a consumer profile based on the received product information, the consumer profile being valid for the residence inhabitant(s). The created consumer profile basically relates to a purchasing behaviour and/or consuming behaviour of the residence inhabitant(s) by taking into account any consumer products having entered the residence 100, as explained above.

The consumer profile may also be updated on a continuous basis as further consumer products enter the residence 100. It should be noted that the profile server 110 may be notified also when an already registered consumer product is leaving the residence 100, which may trigger a consumer profile update. The profile server 110 may be controlled by an operator of a public communication network or by a third party serving various advertisers.

The profile server 110 further provides the current consumer profile to one or more advertising parties, in the figure schematically represented by an “advertiser” 112. The advertiser 112 is then able to create a consumer adapted advertisement and/or offering that is thus adapted to the residence inhabitant(s) by taking the received consumer profile into account. The advertiser 112 thus delivers the adapted advertisement to one or more residence inhabitants in a suitable manner, although the invention is not limited in this respect. As mentioned above, the advertisement may be delivered using any of: an IPTV channel, a telephone message, a paper and an e-mail. Furthermore, the advertisement may be delivered to a communication device or other receiver used by a residence inhabitant regardless of where it is located, thus not necessarily to the actual residence.

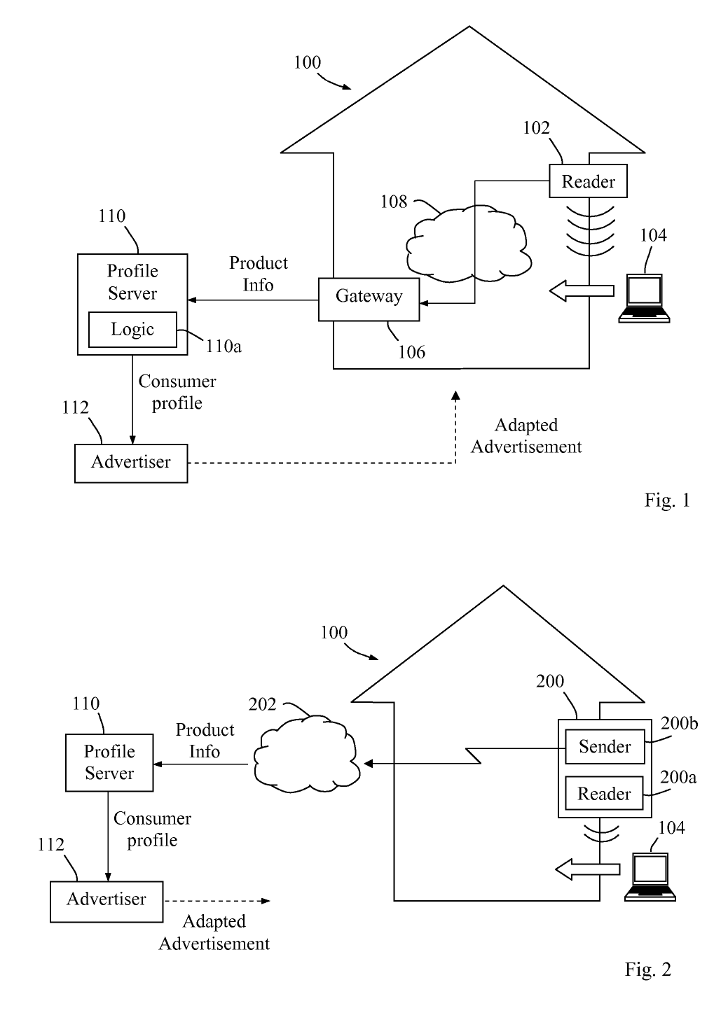

FIG. 2 illustrates a second example of a communication scenario using the same numerals as in the first example for equivalent parts operating in the same manner as described for FIG. 1, which will not be repeated here. One difference, though, is that an integrated communication unit 200 is used for both registering consumer products and communicating read product information to the profile server 110, by including an electronic identity reader 200a coupled to a sending unit 200b that transmits the read product information over a public communication network 202 to profile server 110. For example, the sending unit 200b may be a wireless device for mobile communication over a mobile network, as indicated by the arrow, or a fixed telephone or computer attached to a fixed network.

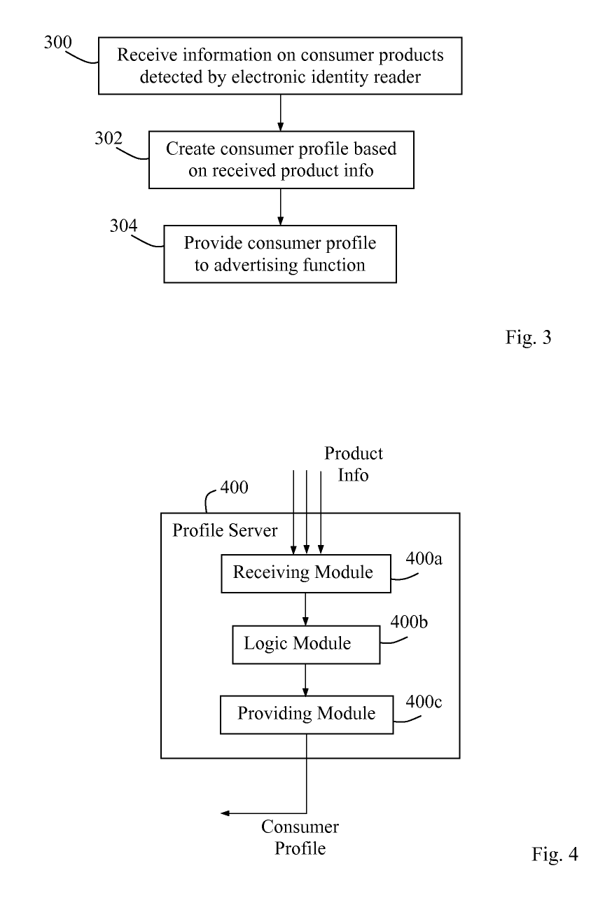

A procedure for supporting advertising activities directed to one or more inhabitants of a residence, will now be described with reference to the flow chart in FIG. 3. This procedure includes steps that can be performed by a profile server or the like having a logic function for the advertising support, e.g. the server 110 shown in FIGS. 1 and 2. In a first step 300, the profile server receives information regarding consumer products or appliances that have entered the residence as detected by an electronic identity reader installed at the residence. This step may be executed on a more or less continuous basis, i.e. whenever a consumer product enters the residence and having an RFID tag or bar code attached, the electronic identity reader reads product information therefrom which is transmitted to the profile server, e.g. as described for FIG. 1 or FIG. 2.

At some point, e.g. as soon as information regarding at least one consumer product has been received, the profile server creates a consumer profile for the residence inhabitant(s) based on the received product information, in a next step 302. The created consumer profile relates to a purchasing behaviour and/or consuming behaviour of the residence inhabitant(s).

In a final shown step 304, the profile server provides the consumer profile to an advertising function which is then able to create and deliver a consumer adapted advertisement and/or offering that is adapted to the residence inhabitant(s).

An arrangement in a profile server 400 configured to support advertising activities directed to one or more inhabitants of a residence, will now be described in more detail with reference to FIG. 4. The profile server 400 arrangement may comprise a logic function, e.g. the function 110a described for FIG. 1 above, which can be logically divided into three functional modules 400a-c as follows.

The profile server 400 comprises a receiving module 400a adapted to receive information on consumer products or appliances that have entered the residence as detected by an electronic identity reader, e.g. installed at a main entrance or other suitable location in the residence. The profile server 400 also comprises a logic module 400b adapted to create a consumer profile for the residence inhabitant(s) based on the received product information. From the knowledge of which consumer products or appliances that have entered the residence, the consumer profile is created as relating to a presumed product usage and/or consuming behaviour of the residence inhabitant(s).

The profile server 400 further comprises a providing module 400c adapted to provide the consumer profile to an advertising function (not shown in this figure), to enable creation of consumer adapted advertisements and/or offerings. Thereby, advertisements can be delivered which are thus adapted to the needs and preferences of the residence inhabitant(s) based on their presumed purchase and usage of consumer products or appliances that have entered the residence, as detected by the electronic identity reader.

It should be noted that FIG. 4 merely illustrates the functional modules in the profile server arrangement in a logical sense, although the skilled person is free to implement these functions in practice using suitable software and hardware means. Thus, the invention is generally not limited to the shown structure with the modules 400a, 400b and 400c, while they may be configured to operate according to the methods and procedures described above for FIGS. 1-3, where appropriate.

For example, the receiving module 400a may be further adapted to receive the product information from a communication equipment (nor shown) to which the electronic identity reader is connected. In another example, the logic module 400b is further adapted to create the consumer profile by determining expected preferences or needs of the residence inhabitant(s) based on assumed usage of the detected consumer products.

By implementing the invention according to any of the above-described embodiments, more relevant advertisements can be delivered to consumers living in individual residences and households, by taking their presumed purchase and usage of consumer products or appliances into account when creating the consumer profile.

Since this solution is not limited to products sold by a single seller, or by a limited group of cooperating sellers, a much broader view of the customer's consuming habits can be obtained by taking any products that have entered the residence into account, regardless of the sellers. Moreover, if the advertisements are made more relevant to the receiving potential customers by using this solution, the consumers may become less indifferent to such advertisements and even less inclined to block them. It will then be generally easier to reach potential customers for product and service providers by means of advertising.

While the invention has been described with reference to specific exemplary embodiments, the description is generally only intended to illustrate the inventive concept and should not be taken as limiting the scope of the invention. The invention is defined by the appended claims.

1.-16. (canceled)

17. A method performed by a profile server of supporting advertising activities directed to one or more inhabitants of a residence, the method comprising:
receiving information regarding consumer products or appliances that have entered the residence as detected by an electronic identity reader installed at the residence, wherein each time product information is read by the electronic identity reader as a consumer product enters the residence by reading an RFID (Radio Frequency Identification) tag or bar code attached to the consumer product and containing information on the consumer product, the product information is sent to the profile server, and
creating a consumer profile for the residence inhabitant(s) based on the received product information, said consumer profile relating to a purchasing behaviour and/or consuming behaviour, wherein creating the consumer profile includes determining expected preferences or needs of the residence inhabitant(s) based on assumed usage of the detected consumer products, and
providing the consumer profile to an advertising function to enable creation of a consumer adapted advertisement and/or offering that is adapted to the residence inhabitant(s).

18. A method according to claim 17, wherein the electronic identity reader detects at least an identity from the RFID tag or bar code attached to the consumer product or appliance entering the residence.

19. A method according to claim 17, wherein said product information is received from a communication equipment to which the electronic identity reader is connected.

20. A method according to claim 19, wherein the communication equipment includes a gateway serving a local network in the residence, or a sending unit integrated with the electronic identity reader.

21. A method according to claim 17, wherein the consumer products or appliances that can be detected by the electronic identity reader belong to any of consumer electronic devices, home appliances, books, music, films, clothes, food, furniture and tools.

22. A method according to claim 17, wherein the advertising function delivers said consumer adapted advertisement and/or offering to the residence using any of an IPTV channel, a telephone message, a paper and an e-mail.

23. A method according to claim 17, wherein the received product information relates to any of type of detected consumer product and characteristics of detected consumer product.

24. A method according to claim 17, wherein operations of receiving, creating, and providing are performed by a profile server comprising a logic function.

25. An arrangement in a profile server configured to support advertising activities directed to one or more inhabitants of a residence, wherein the profile server comprises:
a receiving module adapted to receive information regarding consumer products or appliances that have entered the residence as detected by an electronic identity reader installed at the residence, wherein each time product information is read by the electronic identity reader as a consumer product enters the residence by reading an RFID tag or bar code attached to the consumer product and containing information on the consumer product, the product information is sent to the profile server,
a logic module adapted to create a consumer profile for said residence inhabitant(s) based on the received product information, said consumer profile relating to a purchasing behaviour and/or consuming behaviour, and to create the consumer profile by determining expected preferences or needs of the residence inhabitant(s) based on assumed usage of the detected consumer products, and
a providing module adapted to provide the consumer profile to an advertising function to enable creation of a consumer adapted advertisement and/or offering that is adapted to the residence inhabitant(s).

26. An arrangement according to claim 25, wherein the electronic identity reader detects at least an identity from the RFID tag or bar code attached to the consumer product or appliance entering the residence.

27. An arrangement according to claim 25, wherein the receiving module is further adapted to receive said product information from a communication equipment to which the electronic identity reader is connected.

28. An arrangement according to claim 27, wherein the communication equipment includes a gateway serving a local network in the residence, or a sending unit integrated with the electronic identity reader.

29. An arrangement according to claim 25, wherein the consumer products or appliances belong to any of consumer electronic devices, home appliances, books, music, films, clothes, food, furniture and tools.

30. An arrangement according to claim 25, wherein the received product information relates to any of type of detected consumer product and characteristics of detected consumer product.
